(19) United States
(12) Patent Application Publication
(10) Pub. No.: US 2019/0277420 A1
(43) Pub. Date: Sep. 12, 2019

(54) THERMALLY ACTIVATED FLOW STOP VALVE

(71) Applicants: Thomas R. Crane, Plymouth, MN (US); Charles G. KEITH, Plymouth, MN (US)

(72) Inventor: Charles G. Keith, Plymouth, MN (US)

(21) Appl. No.: 16/302,376

(22) PCT Filed: May 17, 2017
(86) PCT No.: PCT/US2017/033024

§ 371 Date: Nov. 16, 2018

Related U.S. Application Data
(60) Provisional application No. 62/338,352, filed on May 18, 2016.

(51) Int. Cl. F16K 31/00

(52) U.S. Cl. CPC F16K 31/002; F16K 17/38

(57) ABSTRACT

Embodiments include a thermally activated flow valve. The valve comprises a valve body defining an input portion and an output portion; and an expanding element disposed within the valve body; wherein the valve includes an open configuration and a closed configuration, when the valve is in the open configuration the input portion is in fluid communication with the output portion, when the valve is in the closed configuration the input portion is not in fluid communication with the output portion; wherein when the expanding element is exposed to a temperature above a threshold temperature the expanding element expands and terminates the fluid communication between the input portion and the output portion thereby transitioning the valve from the open configuration to the closed configuration.

This application is being filed as a PCT International Patent application on May 17, 2017, in the name of Thomas R. Crane, applicant for the designation of all countries and Charles G. Keith, a U.S. Citizen, applicant and inventor for the designation of all countries, and claims priority to U.S. Provisional Patent Application No. 62/338,352, filed May 18, 2016, the contents of which are herein incorporated by reference in its entirety.

### FIELD OF THE TECHNOLOGY

The present application relates to a valve for a fluid system. More specifically, the present application relates to a thermally activated flow stop valve for a fluid system, such as a system for distributing liquid or gaseous propane or natural gas.

### BACKGROUND

Flammable fluids (such as methane gas, propane gas, liquid gasoline or liquid aviation fuel) are used in residential, industrial, and transportation applications. Flammable fluids frequently enter or are stored in a system in one area, but are needed in a different area. Flammable fluids are therefore transported through a conduit, frequently piping or hoses, from the place the fluid enters or is stored at in the system to the place the flammable fluids are needed. If the conduit in which the flammable fluids (which can include both gases and liquids) are contained is exposed to a fire or increased temperatures, a dangerous situation exists because the conduit can become compromised, thereby allowing the flammable fluids to escape if the conduit is breached. In such cases a fire can ensue, and the fire can continue to be actively fed by ongoing delivery of the flammable fluid to the fire site. For example, if the conduit is subjected to a fire, the conduit can become compromised, resulting in a larger fire and/or an explosion. An example of such circumstances is if the supply hose from a LP tank to a residential grill is breached.

Therefore, a need exists for a way to shut off or limit the flow of flammable fluids, including flammable gases, in the event of an elevated temperature, such as caused by a fire or explosion to prevent further danger.

### SUMMARY

An embodiment described herein includes a thermally activated flow valve. The valve can include a valve body defining an input portion and an output portion; and an expanding element disposed within the valve body. The valve includes an open configuration and a closed configuration. When the valve is in the open configuration the input portion is in fluid communication with the output portion, when the valve is in the closed configuration the input portion is not in fluid communication with the output portion. When the expanding element is exposed to a temperature above a threshold temperature the expanding element expands and terminates the fluid communication between the input portion and the output portion thereby transitioning the valve from the open configuration to the closed configuration.

In an embodiment, when the expanding element expands the expanding element forces a blocking element to a position between the input portion and the output portion where the blocking element terminates the fluid communication between the input portion and the output portion.

In an embodiment, the blocking element is cone shaped.

In an embodiment, the expanding element is enclosed within a housing.

In an embodiment, the housing comprises a first part and a second part. In an embodiment, the first part of the housing is the blocking element.

In an embodiment, the blocking element is suspended within the valve body by a holding element.

In an embodiment, the expanding element includes CE-TAC.

In an embodiment, the expanding element expands to increase its volume by at least 50 percent.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope of the present application is defined by the appended claims and their legal equivalents.

### BRIEF DESCRIPTION OF THE FIGURES

The technology may be more completely understood in connection with the following drawings, in which:

FIG. 1 is a schematic of a fluid system, according to an embodiment.

FIG. 2 is a cross-section view of a valve in an open configuration, according to an embodiment.

FIG. 3 is a cross-section view of the valve in FIG. 2 in a closed configuration, according to an embodiment.

FIG. 4 is a perspective view of an expanding element, according to an embodiment.

FIG. 5 is a cross-section view of a valve in an open configuration, according to an embodiment.

FIG. 6 is a cross-section view of the valve in FIG. 5 in a closed configuration, according to an embodiment.

FIG. 7 is a cross-section view of an expanding element within a housing, according to an embodiment.

FIG. 8 is a perspective view of an expanding element within a housing, according to an embodiment.

FIG. 9 is a cross-section view of a valve in an open configuration, according to an embodiment.

FIG. 10 is a cross-section view of the valve in FIG. 9 in a closed configuration, according to an embodiment.

FIG. 11 is a perspective view of an expanding element, according to an embodiment.

While the technology is susceptible to various modifications and alternative forms, specifics thereof have been shown by way of example and drawings, and will be described in detail. It should be understood, however, that the application is not limited to the particular embodiments described. On the contrary, the application is to cover modifications, equivalents, and alternatives falling within the spirit and scope of the technology.

### DETAILED DESCRIPTION

The embodiments of the present technology described herein are not intended to be exhaustive or to limit the technology to the precise forms disclosed in the following detailed description. Rather, the embodiments are chosen and described so that others skilled in the art can appreciate and understand the principles and practices of the present technology.

All publications and patents mentioned herein are hereby incorporated by reference. The publications and patents disclosed herein are provided solely for their disclosure. Nothing herein is to be construed as an admission that the inventors are not entitled to antedate any publication and/or patent, including any publication and/or patent cited herein.

Described herein is a valve for stopping the flow of fluid within a system when the valve is exposed to an elevated temperature above a threshold or exposed to an elevated temperature for an extended period of time. The valve can provide a mechanical flow stoppage that obstructs the flow of fluid through at least a portion of a system, such that fluid is prevented from reaching connected conduit that is downstream of the valve. The valve can include an expanding element that expands when exposed to the elevated temperature. When expanded the expanding element can block or close an aperture that the fluid was flowing through prior to the expanding element blocking or closing the aperture. In some embodiments, the expanding element can expand into the aperture to stop the flow of fluids. In some embodiments, the expanding element can expand and force a blocking element into a position where the blocking element blocks or closes the path of fluids flowing through the valve.

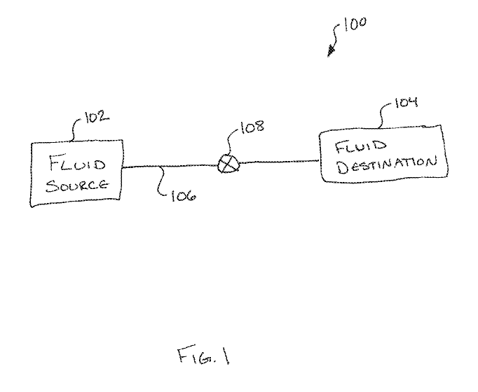

Now, in reference to the drawings, FIG. 1 shows a schematic of a system 100 comprising a fluid source 102, a fluid destination 104, a conduit 106, and a valve 108. Fluid can travel from the fluid source 102 through conduit 106, such as to transport the fluid (for example propane or LP gas) from the fluid source 102 to the fluid destination 104.

The fluid traveling from the fluid source 102 to the fluid destination 104 through conduit 106 can include a gas, a liquid, or a combination of gas and liquid. In an embodiment, the fluid can be flammable. For example, the fluid can include a flammable gas such as natural gas (methane), propane, butane, or hydrogen. The fluid can include a liquid, such as gasoline, diesel fuel, or lubricants. It is understood that there are additional flammable gases and liquids that could travel through the conduit 106. The conduit 106 can include corrugated stainless steel tubing (“CSST”). The conduit 106 can also include external gas risers, piping, or appliance connectors. An appliance connector can couple piping to an appliance.

The system 100 can comprise a fluid source 102, such as where fluid is produced, stored, or introduced into the system 100. The fluid 100 can originate or be introduced into the conduit from the fluid source 102. An example of a fluid source 102 can include a fluid tank, such as a gas tank or a propane cylinder. In an embodiment, the fluid source 102 can include a fluid connection, such as when the fluid is coming from a component external from the system 100. For example, a fluid source 102 could include a connection with a city provided natural gas line to a house or other building.

The system 100 can include a fluid destination 104, such as where the fluid will travel to. The fluid 100 can be used or stored at the fluid destination 104. Various examples of the fluid destination 104 can include a burner for a grill, a stove, a fluid tank, or an engine.

The valve 108 is a thermally activated flow stop valve. The valve 108 can be configured such that when the valve is exposed to a temperature above a threshold temperature, the valve 108 closes thereby preventing flow of fluid through the valve 108. In various embodiments, the system 100 can include more than one thermally activated flow stop valve. In an embodiment, the system 100 can include two or more valves 108. In an embodiment, the system 100 can include five or more valves 100. In an embodiment, the system 100 can include a valve 108 at regular intervals, such as one valve every 2 feet of conduit 106 or one valve every 10 feet of conduit 106.

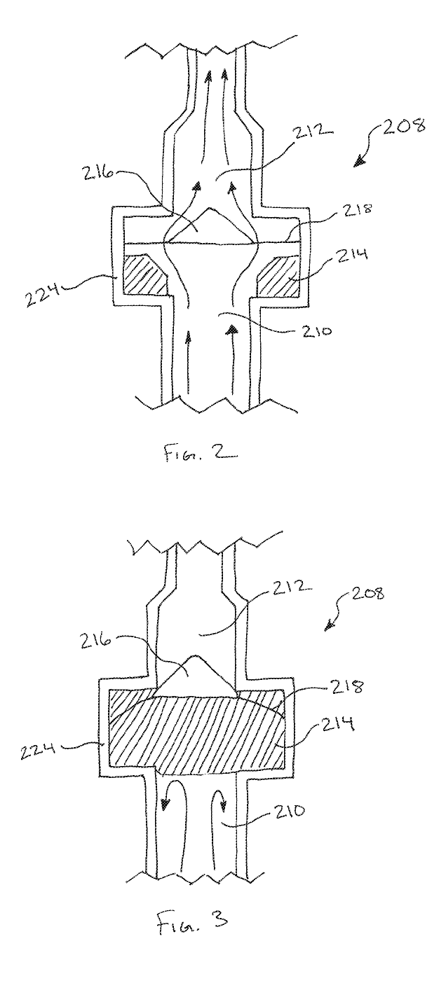

FIG. 2 shows a cross-section view of a valve 208 in an open configuration, according to an embodiment. In the open configuration, the valve 208 can permit fluid to flow through the valve 208, as represented by the arrows in FIG. 2.

The valve 208 can include a valve body 224. In various embodiments, the valve body 224 can have a large outside circumference or larger outer perimeter compared to the adjacent conduit, such as to provide a space or cavity for an expanding element 214 and/or a blocking element 216.

The valve body 224 can define an input portion 210 and an output portion 212. The valve body 224 can define a fluid path between the input portion 210 and the output portion 212, such that input portion 210 can be in fluid communication with the output portion 212. Fluid flowing through the conduit 206 can enter the valve 208 at the input portion 210. Fluid can travel through the valve 208 and exit the valve 208 at the output portion 212. In various embodiments, the input portion 210 can be coupled to a section of the conduit 206 that is upstream from the valve 208 and the output portion 212 can be coupled to a second of the conduit that is downstream from the valve 208.

The valve 208 can include an expanding element 214. In an embodiment, the expanding element 214 can include a heat activated polymer. The heat activated polymer can drastically increase in size when exposed to an elevated temperatures, such as caused by a fire. In an embodiment, the expanding element 214 can include CE-TAC. The expanding element 214 can increase in size when exposed to a temperature above a threshold temperature. The expanding element 214 when expanded can substantially stop the flow of fluid through the valve 208, such as by occupying, filling or covering the aperture that the fluid was traveling through.

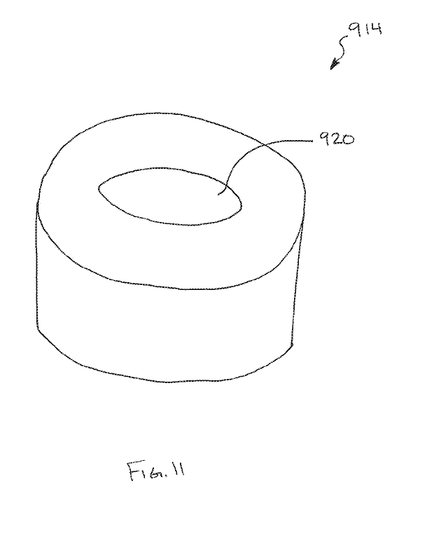

In some embodiments, the expanding element 214 can force a blocking element 216 into a position where the blocking element 216 stops or prevents the flow through the valve 208. In some embodiments, the expanding element 214 can block or fill the aperture itself to stop the flow, as shown in FIG. 10. In some embodiments, the expanding element 214 and a blocking element 216 can both individually prevent flow through the valve, such as to provide at least two levels of blockage or protection from fluids flowing through the valve 208.

In various embodiments, when the valve 208 is in an open configuration, the blocking element 216 can be held in a position where the blocking element 216 does not terminate the flow of fluid through the valve 208, such as shown in FIG. 2. In some embodiments, the blocking element 216 can be suspended within the valve body 224. In various embodiments, the blocking element 216 can be held in place by a holding element 218. In various embodiments, the holding element 218 can define one or more through holes, such that fluid can flow through the holding element 218 and around the blocking element 216 to the output portion 212. In some embodiments, the holding element 218 can include an elastic or deformable material, such that the holding element 218 can stretch or deform when the expanding element 214 expands and moves the position of the blocking element 216.

In various embodiments, the blocking element 216 can be rigid, such that it does not substantially bend or deform in the closed configuration or when transitioning from the open configuration to the closed configuration. In an embodiment, the blocking element 216 can have a cone shape, such as shown in FIGS. 2 and 3. In other embodiments, the blocking element 216 can have a shape that is the inverse shape of a portion of the inner valve body wall, such that the blocking element 216 can mate with the inner valve body wall to create a seal which does not permit fluid flow through the valve.

FIG. 2 shows a cross-section of the valve 208 in an open configuration, allowing fluid to flow through the valve 208. Upon experiencing an elevated temperature of sufficient amount to expand the expanding element 214, the valve 208 can transition into a closed configuration as shown in FIG. 3. In the closed configuration, shown in FIG. 3, the expanding element 214 has expanded to force the blocking element 216 into a position where the blocking element 216 occupies the path of fluid flowing through the valve 208 thereby stopping the flow. The expanding element 214 also blocks the path of the fluid thereby stopping the flow. Also shown in FIG. 3, the holding element 218 deforms to allow the blocking element 216 to transition from the position where the blocking element 216 allows fluid to flow through the valve to the position where the blocking element 216 prevents flow through the valve.

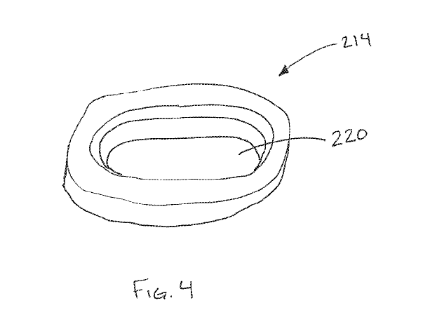

FIG. 4 shows a perspective view of the expanding element 214 in the unexpanded state, such as in FIG. 2. In the unexpanded state, the expanding element 214 can allow fluid to flow through and past the expanding element 214, such as through a central aperture 220. In various embodiments of the expanding element 214 in the expanded state, the central aperture 220 can be closed by the expanding element thereby preventing fluid from flowing through the expanding element 214.

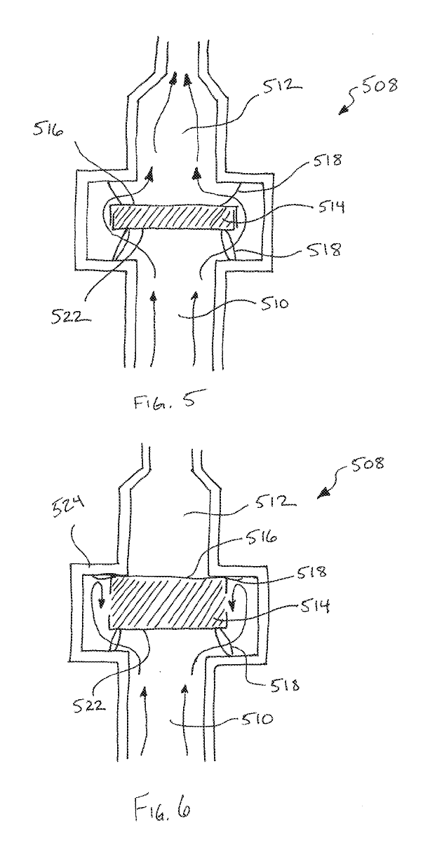

FIG. 5 shows a cross-section view of a valve 508 in an open configuration, according to an embodiment. The configuration of the valve 508 can have similarities to the valve 208 shown in FIGS. 2 and 3. The valve 508 can include a valve body 524, an input portion 510, and output portion 512, an expanding element 514, a blocking element 516 and a holding element 218.

In an embodiment, the valve 508 can include a housing 522 which the expanding element 514 (in an unexpanded state) is housed within. In some embodiments, the housing 522 can include the blocking element 516. The housing 522 can enclose the expanding element 514 within, such that when the expanding element 514 expands the housing 522 is forced open. In some embodiments, the housing 522 can include a first part and a second part. The first part can include the blocking element 516. The second part can be stationary or in a fixed location, such that it does not substantially move when the valve transitions from the open configuration to the closed configuration. In various embodiments, the housing 522 can be held in place by a holding element 522. The holding element 522 can suspend the housing 522 within the valve body. In an embodiment, in the open configuration, the housing 522 does not contact any portions of the valve body. The holding element 522 can define one or more through holes to allow fluid to pass around the housing 522 when the valve 508 is in an open configuration.

FIG. 6 shows a cross-section view of the valve in FIG. 5 in a closed configuration, according to an embodiment. When the expanding element 514 is exposed to a sufficient temperature, the expanding element 514 can expand and force the blocking element 516 (or the top portion of the housing 522) to block the fluid path from the input portion 510 to the output portion 512. In an embodiment, the blocking element 516 can include a planar or flat portion that abuts against a portion of the valve body 524 to close the fluid path and stop the flow of fluid through the valve 508.

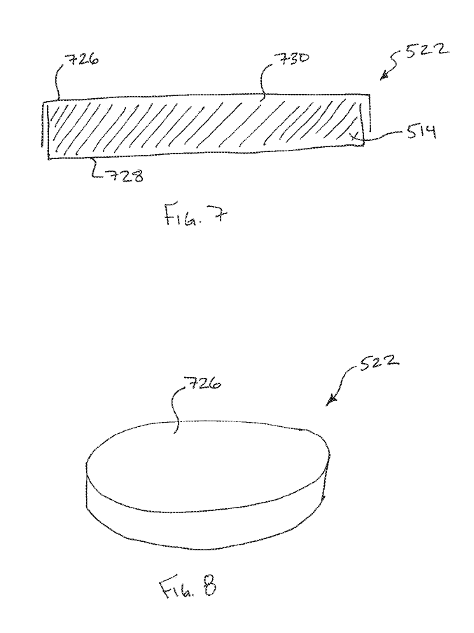

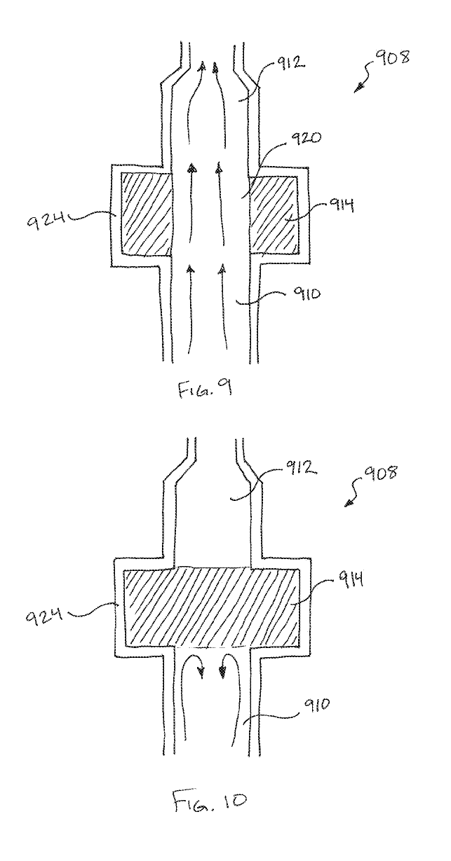

FIG. 7 is a cross-section view of an expanding element 514 within a housing 522, according to an embodiment. FIG. 8 shows a perspective view of the housing 522, according to an embodiment. In various embodiments, the housing 522 can include a first portion 726 and a second portion 728. The first portion 726 and the second portion 728 can define a cavity 730. The expanding element 514 is disposed within the cavity 730. In an embodiment, at least 50% of the cavity can be occupied by the unexpanded expanding member. In an embodiment, at least 75% of the cavity can be occupied by the unexpanded expanding member. In an embodiment, at least 90% of the cavity can be occupied by the unexpanded expanding member. In an embodiment, at least 95% of the cavity can be occupied by the unexpanded expanding member.

In various embodiments, the housing 522 is disposed within the valve body. The housing 522 can be suspended or held within the valve body, such as in a location that when the expanding element 514 has not expanded allows for the input portion to be in fluid communication with the output portion and when the expanding element 514 expands, at least a portion of the housing 522 terminates the fluid communication between the input portion and the output portion.

The housing 522 can include a rigid material, such as metal. In various embodiments, the first portion 726 includes the same type of material as the second portion 728.

Upon expanding, the expanding element 514 can separate the first portion 726 from the second portion 728. In some embodiments, expanding the expanding member can move or displace the first portion 726 into a position where the first portion 726 prevents the input portion from being in fluid communication with the output portion. In an embodiment, the first portion 726 can be configured to mate with a portion of the valve body to provide a secure seal when the first portion 726 is moved into a position in which it blocks the fluid communication between the input portion and the output portion.

In various embodiments, the housing 522 can be generally cylindrical. In some embodiments, the housing 522 can have a cross-sectional shape similar to the cross-sectional shape of the valve body. In some embodiments, the valve can have a circular cross-section and the housing 522 can also have a circular cross-section.

FIG. 9 shows a cross-section view of a valve 908 in an open configuration, according to an embodiment. The configuration of the valve 908 can have some similarities with the valve 208 shown in FIGS. 2 and 3. The valve 908 can include a valve body 924, an input portion 910, and output portion 912, and an expanding element 914.

In the open configuration, the input portion 910 can be in fluid communication with the output portion 912, such that fluid can flow from the input portion 910 to the output portion 912. In various embodiments, the expanding element 914 can define a central aperture 920 of the expanding element. Fluid flowing from the input portion 910 can travel through the central aperture 920 to the output portion 912.

Upon experiencing a temperature above a threshold temperature, the expanding element 914 can expand a sufficient amount to close or block the central aperture 920, thereby terminating the fluid communication between the input portion 910 and the output portion 912, such as shown in FIG. 10. In an embodiment, the expanded expanding element 914 along with the valve body can define a wall or blockage between the input portion 910 and the output portion 912 to stop flow through the valve.

FIG. 11 shows a perspective view of an expanding element 914, according to an embodiment. FIG. 11 shows the expanding element 914 prior to being subjected to a temperature which causes it to expand, similar to valve 908 in FIG. 9. In various embodiments, the expanding element 914 can define a central aperture 920 to permit fluid to flow through the valve.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration to. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this technology pertains. All publications and patent applications are herein incorporated by reference to the same extent as if each individual publication or patent application was specifically and individually indicated by reference.

The technology has been described with reference to various specific and preferred embodiments and techniques. However, it should be understood that many variations and modifications may be made while remaining within the spirit and scope of the technology.

1. A thermally activated flow valve, comprising:
a valve body defining an input portion and an output portion; and
an expanding element disposed within the valve body;
wherein the valve includes an open configuration and a closed configuration, when the valve is in the open configuration the input portion is in fluid communication with the output portion, when the valve is in the closed configuration the input portion is not in fluid communication with the output portion;
wherein when the expanding element is exposed to a temperature above a threshold temperature the expanding element expands and terminates the fluid communication between the input portion and the output portion thereby transitioning the valve from the open configuration to the closed configuration.

2. The thermally activated flow valve according to claim 1, wherein when the expanding element expands the expanding element forces a blocking element to a position between the input portion and the output portion where the blocking element terminates the fluid communication between the input portion and the output portion.

3. The thermally activated flow valve according to claim 2, wherein the blocking element is cone shaped.

4. The thermally activated flow valve according to claim 2, wherein the expanding element is enclosed within a housing.

5. The thermally activated flow valve according to claim 4, wherein the housing comprises a first part and a second part.

6. The thermally activated flow valve according to claim 5, wherein the first part of the housing is the blocking element.

7. The thermally activated flow valve according to claim 1, wherein the blocking element is suspended within the valve body by a holding element.

8. The thermally activated flow valve according to claim 1, wherein the expanding element includes CE-TAC.
